(19) United States
(12) Patent Application Publication
(10) Pub. No.: US 2024/0017787 A1
(43) Pub. Date: Jan. 18, 2024

(54) Electric Trike

(71) Applicant: Rad Power Bikes Inc., Seattle, WA (US)

(72) Inventors: Trevor KNAPP, Seattle, WA (US); Stefan Benier, Seattle, WA (US); Cory Tsai, Seattle, WA (US); Matthew Arksey, Seattle, WA (US); Erik Klosiewski, Seattle, WA (US); Tyler Gilbert, Seattle, WA (US); Sarah Bruce Courtney, Seattle, WA (US)

(21) Appl. No.: 18/351,755

(22) Filed: Jul. 13, 2023

Related U.S. Application Data
(60) Provisional application No. 63/389,765, filed on Jul. 15, 2022.

(51) Int. Cl. B62K 5/06; B62K 5/027; B62M 6/40; B62J 13/00

(52) U.S. Cl. CPC B62K 5/06; B62K 5/027; B62M 6/40; B62J 13/00

(57) ABSTRACT

Electric trikes (or tricycles) or other electric three-wheeled vehicles, are described. The electric trikes include components or features that enhance the operation, assembly, control, and/or use of the electric trikes. For example, various embodiments described herein include attachment plates for frames of the electric trikes, integrated rear racks for the electric trikes, mounting points for the rear racks of the electric trikes, protective components for the electric trikes, shade/sun covers for the electric trike, and other enhancements.

### CROSS REFERENCE TO RELATED APPLICATIONS

This application claims priority to U.S. Provisional Patent Application No. 63/389,765, filed on Jul. 15, 2022, entitled ELECTRIC TRIKE, which is hereby incorporated by reference in its entirety.

### BACKGROUND

Electric bicycles, or e-bikes, are a popular method of transportation for use by individual riders, families, commercial enterprises and fleets, and so on. Unlike traditional bikes, an e-bike provides assisted modes of travel to a rider, including a peddle assist mode that utilizes power from a motor to assist the rider in pedaling and/or a throttle mode where the motor, when engaged, powers the e-bike without any pedaling from the rider.

E-bikes include various electric bicycle or vehicle types, including electric trikes, which have three wheels (e.g., like tricycles), electric scooter/bike hybrids, and other micro-mobility vehicles.

### BRIEF DESCRIPTION OF THE DRAWINGS

Embodiments of the present technology will be described and explained through the use of the accompanying drawings.

FIGS. 1A-1B are diagrams illustrating an electric trike.

FIGS. 2A-2B are diagrams illustrating an attachment plate for an electric trike.

FIG. 3 is a diagram illustrating a chain tensioner for an electric trike.

FIGS. 4A-4B are diagrams illustrating a rear rack and frame for an electric trike.

FIGS. 5A-5B are diagrams illustrating a guard for a chain and axle of an electric trike.

FIG. 6 is a diagram illustrating a cover for an electric trike.

FIG. 7 is a flow diagram illustrating a method of assembling an electric trike.

In the drawings, some components are not drawn to scale, and some components can be combined for discussion of some of the implementations of the present technology. Moreover, while the technology is amenable to various modifications and alternative forms, specific implementations have been shown by way of example in the drawings and are described in detail below. The intention, however, is not to limit the technology to the particular implementations described. On the contrary, the technology is intended to cover all modifications, equivalents, and alternatives falling within the scope of the technology as defined by the appended claims.

### DETAILED DESCRIPTION

### Overview

Electric trikes (or tricycles) or other electric three-wheeled vehicles, are described. The electric trikes include components or features that enhance the operation, assembly, control, and/or use of the electric trikes. For example, various embodiments described herein include an electric trike with a two-piece frame, attachment plates for frames of the electric trikes, integrated rear racks for the electric trikes, mounting points for the rear racks of the electric trikes, protective components for the electric trikes, shade/sun covers for the electric trike, and other enhancements.

In some embodiments, a frame of an electric trike can include two sections or have a two-piece structure, such as a front frame section that includes a head tube and a down tube, and a rear frame section that includes a seat tube and a rear rack. The frame of the electric trike is assembled or otherwise fixed via an attachment plate or mechanism, which fixes, secure, and/or couples the two frame sections together.

In some embodiments, the frame can support a seat post to position a seat in a low, rear position of the trike. For example, the frame can include an angled seat post or tube, which is supported via a support post and/or rear rack of the trike. In such a position, a rider of the trike can be positioned at a lower center of mass within the trike, providing a more controlled and/or secure operation of the trike, among other benefits.

While the various technologies or enhancements are described with respect to, or for use by, an electric trike, the technologies can be configured or utilized with other bicycles or cycles and/or other wheeled micro-mobility vehicles, mopeds, electric vehicles, and so on.

Various embodiments of the technology will now be described. The following description provides specific details for a thorough understanding and an enabling description of these embodiments. One skilled in the art will understand, however, that these embodiments may be practiced without many of these details. Additionally, some well-known structures or functions may not be shown or described in detail, so as to avoid unnecessarily obscuring the relevant description of the various embodiments. The terminology used in the description presented below is intended to be interpreted in its broadest reasonable manner, even though it is being used in conjunction with a detailed description of certain specific embodiments.

### Examples of Electric Trikes

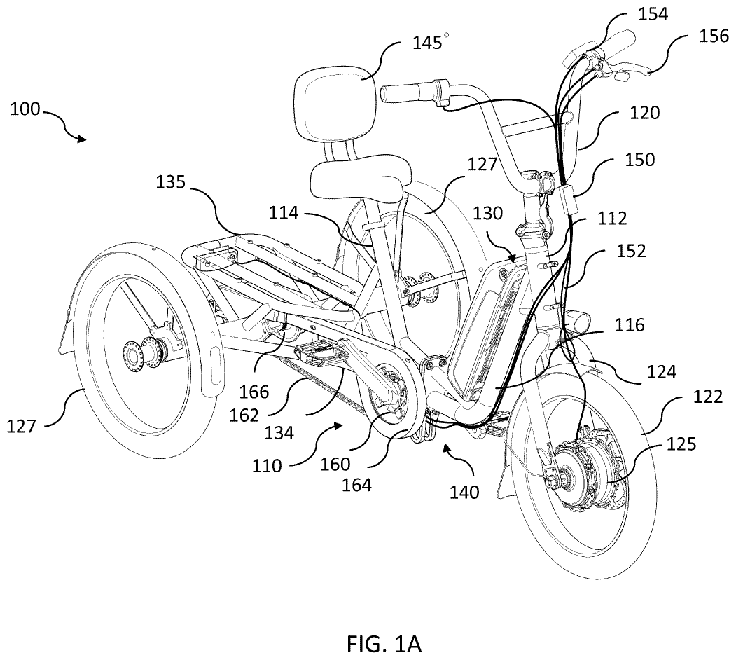

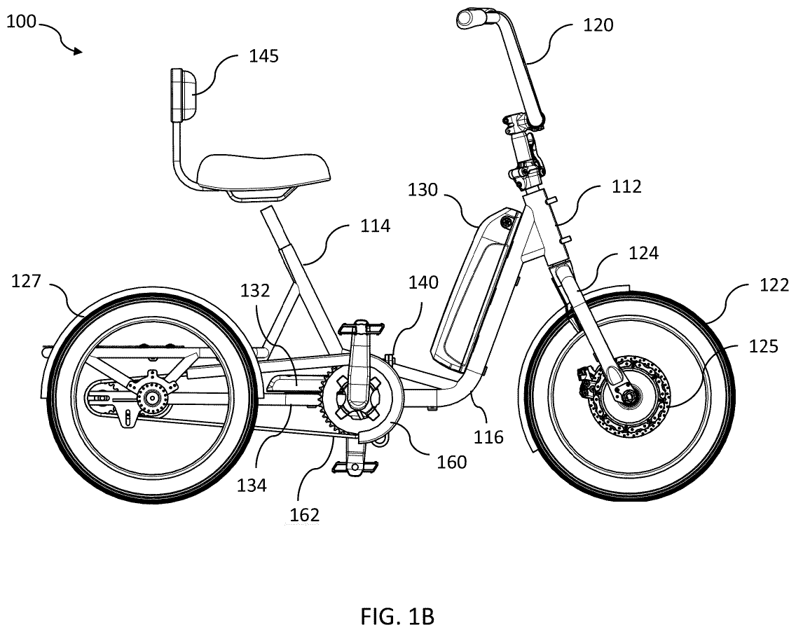

FIGS. 1A-1B depict an electric trike 100. The electric trike 100 includes a frame 110 supported by three wheels, including a front wheel 122 and two rear wheels 127. The frame 110 has a head tube 112, a seat tube 114, and a down tube 116 that extends from the head tube 112 to the seat tube 114.

Handlebars 120 attach to the head tube 112 via a folding stem, which extends to a fork 124 that receives the front wheel 122. The frame 110 supports the electrical components of the electric trike 100. As depicted, a battery 130 is positioned and/or mounted to the down tube 116 (e.g., an upper portion of the down tube 116), and a controller 132 is mounted or disposed to or on top of a chain stay 134. Further, an electric motor 125 (e.g., a hub motor) is mounted to the front wheel 125 (although in some cases the trike 100 may have a mid-drive motor or rear hub motor or rear axle motor, centered between the back wheels 127). During operation of the electric trike 100, the battery pack 130 provides power to the electric motor 125, which propels the electric trike 100 under control of the controller 132.

A seat 145 and seat post is positioned partially in the seat tube 114 and extends or protrudes outwardly from the seat tube 114. The seat post supports the seat 145 (or saddle), upon which a rider sits on the electric trike 100. A rear rack 135 extends from the seat tube 114 (or from various supporting tubes or frame components fixed (e.g., welded) to the seat tube 114) and is positioned between the rear wheels 127.

As described herein, the frame 110, in some embodiments, is a two-piece frame. An attachment plate 140 connects or fixes a front portion of the electric trike 100 to a rear portion of the electric trike 100. For example (and further described herein), the attachment plate 140 or mechanism fixes a front section of the frame 110, which includes the head tube 112 and down tube 116 to a rear section of the frame 110, which includes the seat tube 114 and rear rack 135.

As shown (and further described herein), the attachment plate 140 or mechanism removably fixes the two sections of the frame 110 together (such as during assembly of the trike 100), which also supporting and facilitating the extension of wires or cables 152 from the front to the rear of the frame 110 (e.g., to rear brakes, shifters, lights, the controller 132 and/or other components). A wiring harness 150 can contain or secure the wires/cables 152, such as the wires/cables 152 as they extend down from components (e.g., brakes 156, a control device 154) disposed on the handlebars 120 to the motor 125, brakes, controller 132, battery 130, and so on. The wiring harness 150 can have a shape that conforms to the shape of the frame 110, such as the shape of the head tube 112, in order to facilitate positioning of the harness 150 next to and aligned with the frame 110, in order to securely contain cables that extend along one or more of the tubes between the electrical components.

The electric trike 100 also includes various other components, such as a crankset 160 that supports pedals, a chain 162 that extends from the crankset 150 to a rear axle 166 and/or gear box that operates the rear wheels 127, and a chain cover 164 that contains and/or protects the chain 162 and axle 166.

In addition to the components depicted in FIGS. 1A-1B, the electric trike 100 can include other components, such as brakes and braking systems, various accessories, fenders, various types of rims, tires, or wheels, integrated locks or locking systems, lights and reflectors, bells or other audible alert systems, GPS, screens, and/or other user interfaces or display devices, and so on.

In some cases, the battery 130 can accommodate different types of battery packs. For example, the housing, which can be an extruded casing, can receive a battery pack or assembly having multiple cells and a battery management system (BMS). The assembly can facilitate the sliding in of the assembly into the housing of the battery 130, with end caps being attached after the battery pack is contained within the battery 130. The end caps can include the connectors, ports, indicators (e.g., battery level indicators), and so on.

In addition, the battery 130 can include a configuration of cells that are potted after being placed together within a chassis and/or within the pack. The battery pack can include a chassis, multiple battery cells, a potting compound disposed within the chassis and between the cells, and a bus bar or connection material that connects the cells together on a top surface of the chassis. Further details regarding such a configuration can be found in U.S. patent application Ser. No. 17/714,734, filed on Apr. 6, 2022, entitled BATTERY PACKS FOR ELECTRIC BICYCLES, which is hereby incorporated by reference in its entirety.

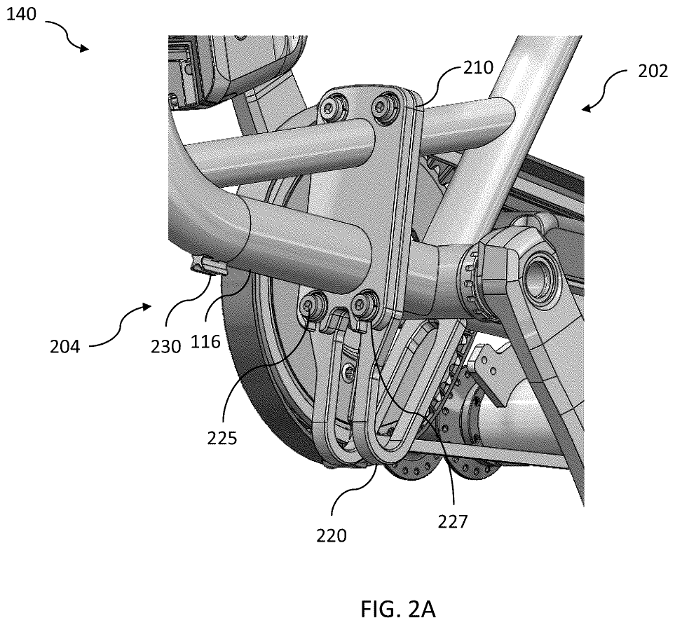

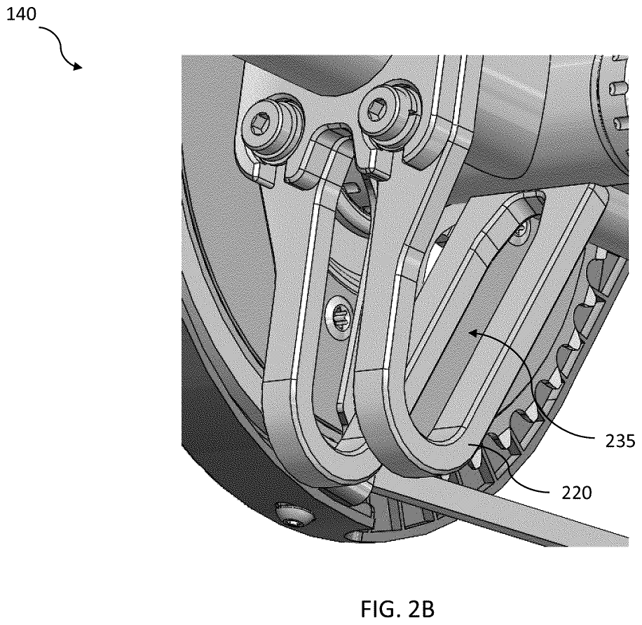

As described herein, the frame 110 of the electric trike 100 includes the attachment plate 140, or attachment mechanism, which facilitates the fixing or attachment of a front portion and rear portion of the electric trike 100 during assembly (or detachment once fixed). FIGS. 2A-2B are diagrams illustrating the attachment plate 140.

The attachment plate 140 includes multiple sub-plates 210, one for each section of the frame 110, which attach to one another via bolts 225 or other attachment components. The bolts 225 are positioned through holes 227 or openings, which receive the bolts 225 and facilitate the fixing of the sub-plates 210 to one another. In some cases, the openings 227 (e.g., the lower openings) are open at the bottom, which enable the bolts 225 to be first placed or secure to one sub-plate 210, with the other sub-plate slid or positioned onto the bolt 225 when fixing or positioning the two sub-plates to one another.

The attachment plate 140 also includes teeth, supports, or plate extensions 220, which extend downwards (e.g., just lower than the crankset to support the weight of the rear frame when unattached to the front half of the frame). The plate extensions 220 include or provide an opening 235 or cavity, which facilitates the extension or threading of wires or cables (e.g., cables 152) from a front area 204 of the electric trike 100 to a rear area 202 of the trike 100. A grommet 230 can guide or position the wires/cables along the down tube 116 and through the opening 235 provided by the plate extensions 220.

Thus, the attachment plate 140 facilitates an efficient and simplified, yet secure, assembly of the front area 204 of the trike 100 to the rear area 202 of the trike 100, among other benefits.

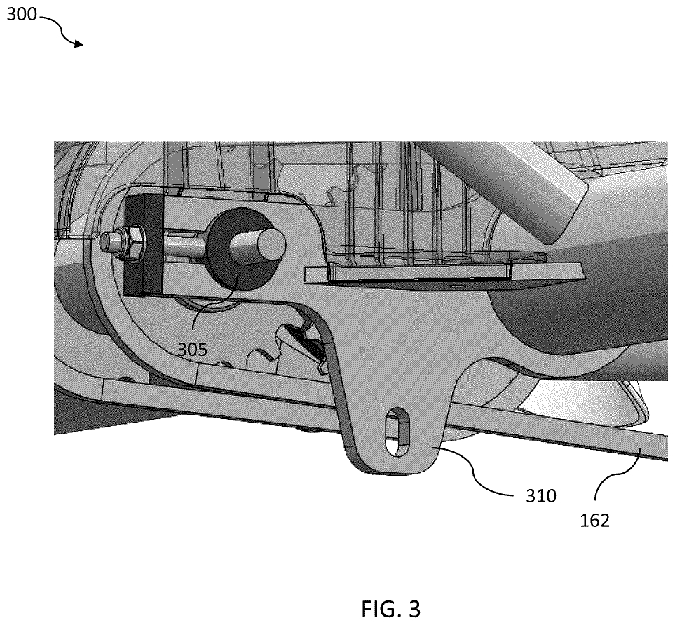

As described herein, the frame can include components that facilitate tensioning a chain, such as the chain 162. FIG. 3 is a diagram 300 illustrating a chain tensioner slot 310, which receives or mounts a chain tensioner (not shown), for an electric trike. The chain tensioner slot 310 is disposed or positioned proximate to a rear axle of an electric trike and enables the chain to have a proper or useful tension via a mounted chain tensioner. In some cases, the chain tensioner slot 310 (e.g., mounting a chain tensioner) is provided along with a tensioner 305 that is mounted to a rear sprocket.

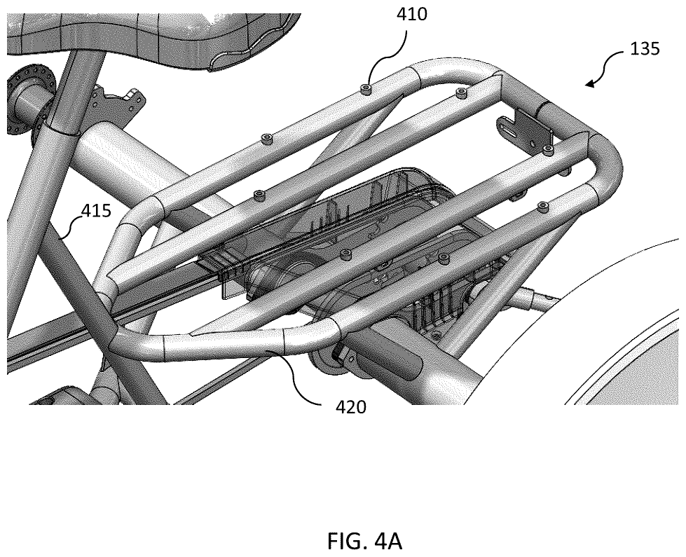

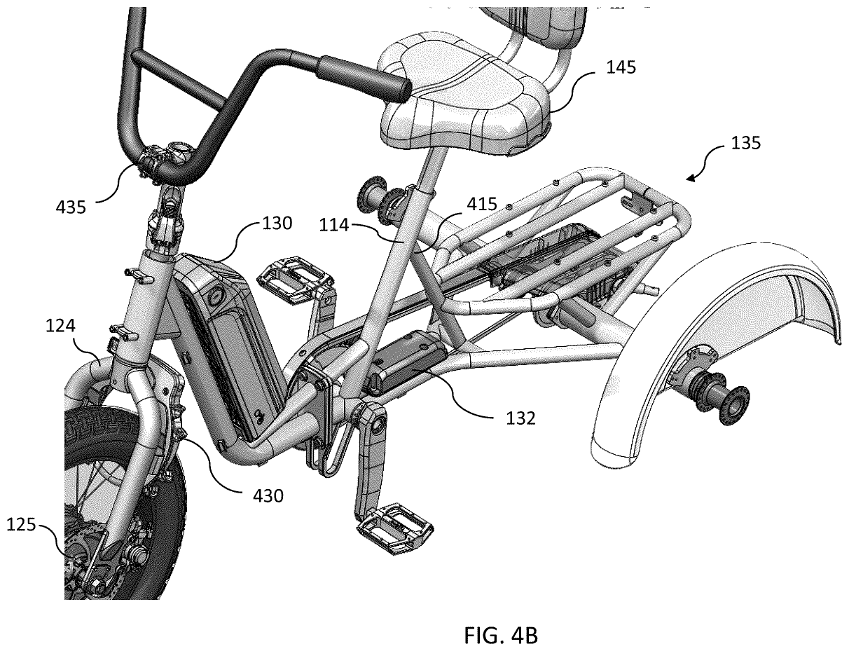

As described herein, the rear rack 135, which can be part of the frame 110 of the electric trike 100, can have various configurations or geometries that facilitate the mounting of cases and other storage or support components to the electric trike 100. FIGS. 4A-4B are diagrams illustrating the rear rack 135 and the frame 110 for an electric trike.

The rear rack 135 can include attachment components 410, which are positioned on different tubes or rack sections, to provide a variety of mounting configurations or geometries for various accessories. For example, the attachment components 410 can receive threaded bolts or screws of accessories, to facilitate the fixing of the accessories to the rack 135.

The attachment components 410 can form and/or provide attachment points for the rear rack 135, such as attachment points in a variety of patterns. For example, the rear rack 135 depicts an octagonal attachment pattern, which enables different accessories (e.g., rear boxes, boards, seats, bins, and so on) to be fixed or removably attached to the rear rack 135.

As depicted, the rear rack 135 is part of the frame 110 and is fixed to the seat tube 114 (or to a support post 415 that supports the seat tube 114) via one or more extension posts or tubes 420. The extension posts 420 provide support for the rear rack 135 as well as additional structure to the frame 110. For example, with the seat tube 114 positioned at an angle towards the rear of the trike 100 (e.g., between 55-80 degrees from a horizontal axis, such as 60-65 degrees from the horizontal), the various support tubes and posts provide support for the seat tube 114 (and the seat 145) at the angle of incline. The support post 415 may be coupled at a similar angle (e.g., when the seat tube 114 extends at an angle of 60 degrees, the support 415 extends at a similar angle of 60 degrees, although in the opposite direction).

Such positioning enables the seat 145 (and a rider sitting on the seat 145) to be positioned lower and towards the rear of trike frame 110, where the frame 110 is relatively heavier and stronger (e.g., towards or above the center of mass of the frame 110).

The frame 110, as depicted in FIG. 4B, can accommodate various components, such as the components of an electrical system of the trike 100. For example, the frame 110 includes the battery 130, the controller 132, and the hub motor 125. The trike 100 can also include a lock (e.g., a wheel lock) 430 positioned on the fork 124 of the trike, and a face plate 435, which fixes the handlebars 120 to the stem of the frame 110.

In some cases, a mechanism in a main neck of the stem allows rotation downwards to enable the handlebars to be positioned for storing the trike 100. For example, a folding stem enables the handlebars 120 to be rotated downwards to a collapsed position, to facilitate the storing or transport of the trike 100, among other benefits.

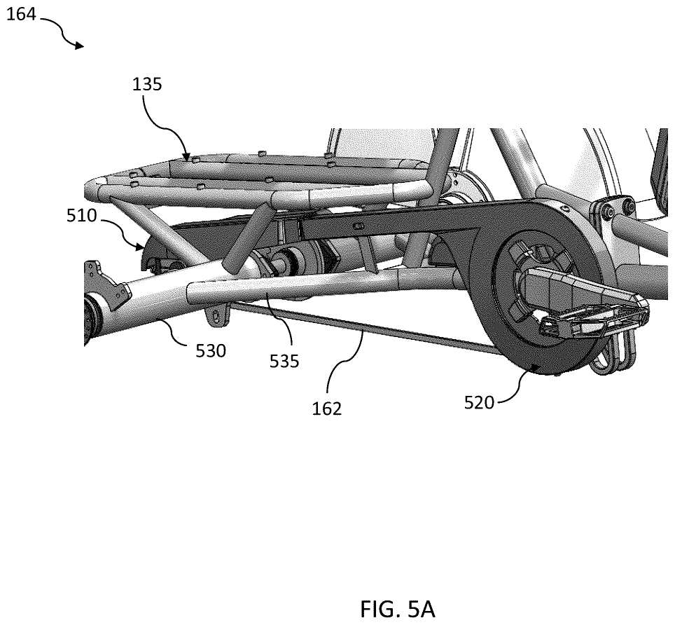

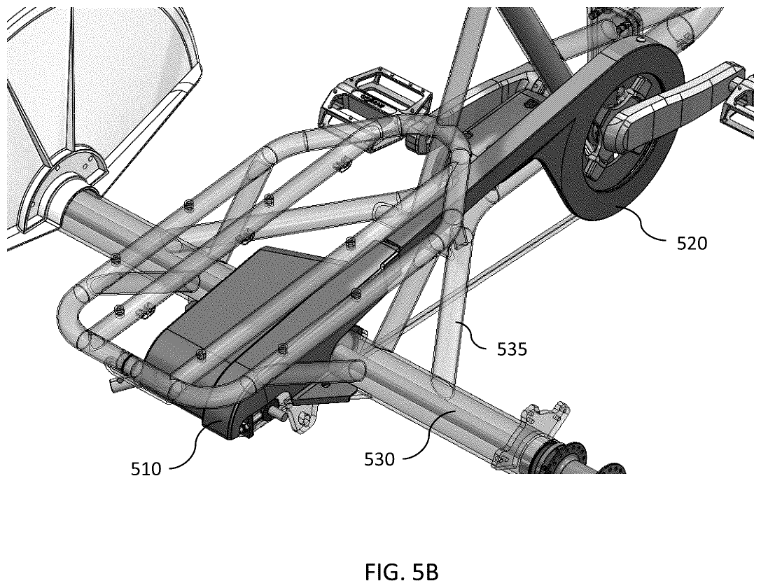

As described herein, the electric trike 100 can include the chain cover 164, which contains and/or protects the chain 162 and axle 166. FIGS. 5A-5B are diagrams illustrating the chain cover 164. The cover 164 can include two sections, a chain guard 520 and an axle guard 510. The cover 164, in some cases, connects the two sections into a single component, which enables the chain and axle to be protected from debris or objects (e.g., bags, clothing) from touching or entering the axle, chain, crankset or gearing mechanisms of the trike 100.

FIGS. 5A-5B also depict rear support posts 535 (e.g., part or all of the chain stay 134), which extend from a rear portion of the frame 110 to a rear post 530, which contains the rear axle and supports the rear wheels 527. As shown, to support the rear rack 135 and provide some flexibility to the rear section of the frame 135, the rear support posts 535 attach to the rear post 530 at a midpoint or middle area of the rear post 530, such as at a point that is midway between the center and an edge of the rear post 530.

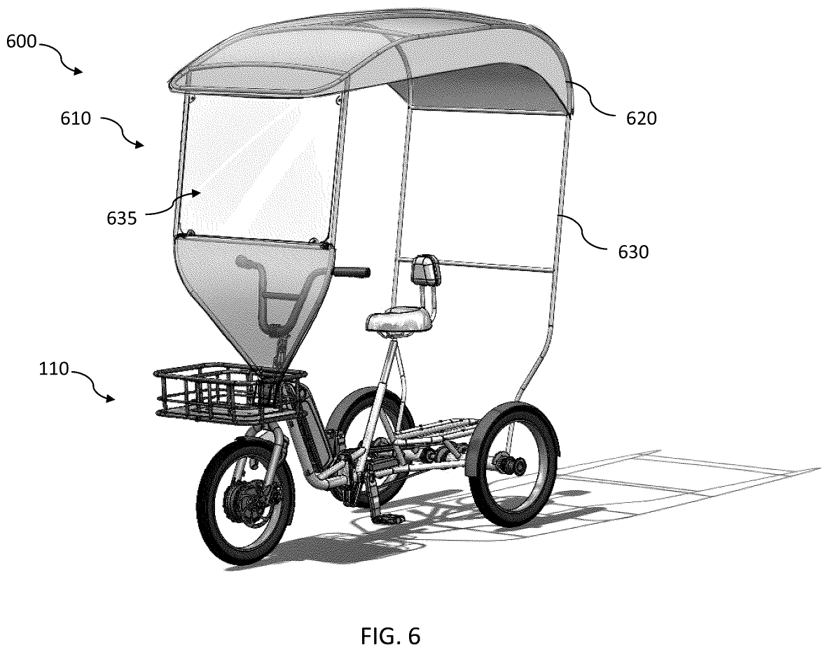

As described herein, the electric trike 100 can include a shade cover or other covering that is positioned above a rider of the trike 100. FIG. 6 is a diagram illustrating a cover 610 for an electric trike 600. The electric trike 600, like the electric trike 100, includes the cover 610, which is removably fixed to the frame 110 of the trike 600. The cover 610 can include a covering (e.g., a nylon or other weatherproof material) 620, which is attached via a cover frame 630. The frame 630 can also include a window 635 or other panels, such as side windows, side panels, and so on.

The cover frame 630, in some cases, is attached to the frame 110 of the trike 100 using thumb screws or other screws or fasteners, such as to a head tube bracket and fender or rear tube brackets. The cover frame 630 can include various sections that detent together, facilitating the folding or collapsing of the cover 610 when not in use, as well as a simple deployment and attachment to the trike 600.

In some cases, the covering 620 can be a single panel or nylon, which extends from the front to the rear of the trike 600. Of course, the cover can take on various configurations or shapes not explicitly depicted herein.

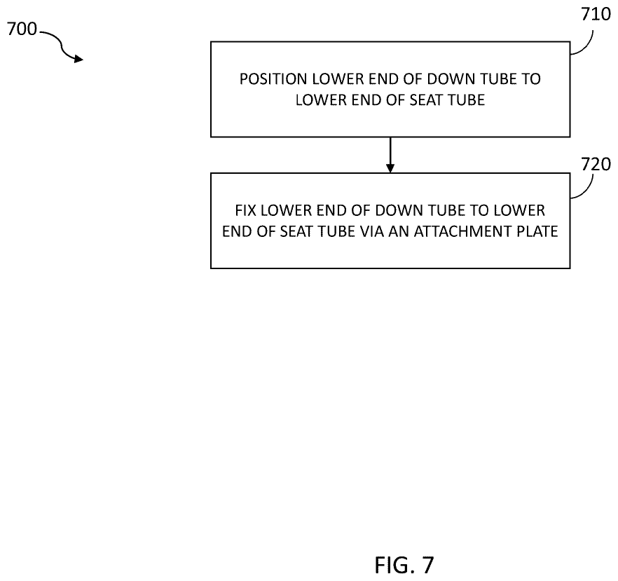

As described herein, the attachment plate 140 can facilitate and/or enable a simple and efficient assembly of an electric tricycle or trike. FIG. 7 is a flow diagram illustrating a method 700 of assembling an electric trike.

In step 710, the method 700 includes positioning a lower end of a down tube of a front frame section of an electric trike to a lower end of a seat tube of a rear frame section. For example, the sub-plate 210 coupled to the down tube 116 is positioned proximate to and/or in contact with the sub-plate 210 coupled to the seat tube 114.

In step 720, the method 700 includes fixing the lower end of the down tube to the lower end of the seat tube via an attachment plate. For example, multiple bolts are fixed to the rear sub-plate coupled to the lower end of the seat tube, and the front sub-plate that is coupled to the lower end of the down tube is slidably attached to the multiple bolts fixed to the rear sub-plate. The multiple bolts are then tightened to secure the front sub-plate to the rear sub-plate, such as via lower openings of the front sub-plate to the multiple bolts. Once the sub-plates are secured, multiple cables may be extended from a front area of the electric trike to a rear area of the electric trike through an opening formed by plate extensions of the attachment plate, as described herein.

Thus, in various embodiments, the attachment plate can enable a simple and easy assembly of the electric trike.

### Example Embodiments of the Disclosed Technology

As described herein, an electric trike or other similar electric bicycle or vehicle can incorporate some or all of the various embodiments described herein.

For example, an electric trike can include a front frame section, a rear frame section, and an attachment plate that couples or fixes the front frame section to the rear frame section. The front frame section can include a head tube and a down tube, and the rear frame section can include a seat tube and a rear rack.

The attachment plate can fix a lower end of a head tube of the front frame section to a lower end of a seat tube of the rear frame section.

The attachment plate can include sub-plates, such as a first sub-plate fixed to the front frame section, and a second sub-plate fixed to the rear frame section, where multiple bolts (or other similar components) fix the first sub-plate to the second sub-plate. The first sub-plate and the second sub-plate can include upper openings that are completely enclosed and receive one or more of the multiple bolts and lower openings that are partially enclosed and receive one or more of the multiple bolts.

The attachment plate can include two plate extensions that extend under the electric trike and form a cavity to route cables of the electric trike from the front frame section to the rear frame section of the electric trike.

The electric trike, such as within the rear frame section, can include a seat tube that extends at an angle towards a rear of the electric trike, a support post that is fixed to the seat tube to support the seat tube, and a rear rack that is fixed to the support post via two extension posts. The seat tube can extend at an angle that is between 55-80 degrees from a horizontal axis, such as 60-65 degrees from the horizontal.

The rear frame section can include a rear rack that is fixed to a seat post via a support post that supports the seat post. For example, the seat tube can extends at an angle towards a rear of the electric trike to position a seat of the electric trike at least partially above the rear rack.

The electric trike can include a rear rack coupled to a seat post, a rear post that contains a rear axle and extends between rear wheels of the electric trike, and multiple rear support posts that support the rear rack.

The rear rack can have a top surface with multiple attachment points disposed in an octagonal pattern on the top surface of the rear rack.

The electric trike can also include a chain cover having a chain guard that surrounds a chain of the electric trike and an axle guard that surrounds a rear axle of the electric trike.

The chain guard can be coupled to the axle guard to form a single housing for the chain and the rear axle of the electric trike, where the axle guard can enclose a gearing mechanism of the rear axle of the electric trike and where the chain guard encloses the chain and a crankset of the electric trike.

The electric trike can also include a sun cover that removably attaches to various points of the electric trike.

As another example, a method of assembling an electric trike can include positioning a lower end of a down tube of a front frame section of the electric trike to a lower end of a seat tube of a rear frame section and fixing the lower end of the down tube to the lower end of the seat tube via an attachment plate.

Fixing the lower end of the down tube to the lower end of the seat tube via the attachment plate can include fixing multiple bolts to a rear sub-plate of the attachment plate that is coupled to the lower end of the seat tube, slidably attaching a front sub-plate of the attachment plate that is coupled to the lower end of the down tube to the multiple bolts fixed to the rear sub-plate, and tightening the multiple bolts to secure the front sub-plate to the rear sub-plate, such as by lower openings of the front sub-plate to the multiple bolts.

Further, the method of assembling the electric trike can include extending multiple cables from a front area of the electric trike to a rear area of the electric trike through an opening formed by plate extensions of the attachment plate.

### CONCLUSION

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the terms “connected,” “coupled,” or any variant thereof, means any connection or coupling, either direct or indirect, between two or more elements; the coupling of connection between the elements can be physical, logical, or a combination thereof. Additionally, the words “herein,” “above,” “below,” and words of similar import, when used in this application, shall refer to this application as a whole and not to any particular portions of this application. Where the context permits, words in the above Detailed Description using the singular or plural number may also include the plural or singular number respectively. The word “or”, in reference to a list of two or more items, covers all of the following interpretations of the word: any of the items in the list, all of the items in the list, and any combination of the items in the list.

The above detailed description of embodiments of the disclosure is not intended to be exhaustive or to limit the teachings to the precise form disclosed above. While specific embodiments of, and examples for, the disclosure are described above for illustrative purposes, various equivalent modifications are possible within the scope of the disclosure, as those skilled in the relevant art will recognize.

The teachings of the disclosure provided herein can be applied to other systems, not necessarily the system described above. The elements and acts of the various embodiments described above can be combined to provide further embodiments.

Any patents and applications and other references noted above, including any that may be listed in accompanying filing papers, are incorporated herein by reference. Aspects of the disclosure can be modified, if necessary, to employ the systems, functions, and concepts of the various references described above to provide yet further embodiments of the disclosure.

These and other changes can be made to the disclosure in light of the above Detailed Description. While the above description describes certain embodiments of the disclosure, and describes the best mode contemplated, no matter how detailed the above appears in text, the teachings can be practiced in many ways. Details of the electric bike and bike frame may vary considerably in its implementation details, while still being encompassed by the subject matter disclosed herein. As noted above, particular terminology used when describing certain features or aspects of the disclosure should not be taken to imply that the terminology is being redefined herein to be restricted to any specific characteristics, features, or aspects of the disclosure with which that terminology is associated. In general, the terms used in the following claims should not be construed to limit the disclosure to the specific embodiments disclosed in the specification, unless the above Detailed Description section explicitly defines such terms. Accordingly, the actual scope of the disclosure encompasses not only the disclosed embodiments, but also all equivalent ways of practicing or implementing the disclosure under the claims.

From the foregoing, it will be appreciated that specific embodiments have been described herein for purposes of illustration, but that various modifications may be made without deviating from the spirit and scope of the embodiments. Accordingly, the embodiments are not limited except as by the appended claims.

What is claimed is:

1. An electric trike, comprising:
a front frame section;
a rear frame section; and
an attachment plate that couples the front frame section to the rear frame section.

2. The electric trike of claim 1, wherein:
the front frame section includes a head tube and a down tube; and
the rear frame section includes a seat tube and a rear rack.

3. The electric trike of claim 1, wherein the attachment plate fixes a lower end of a down tube of the front frame section to a lower end of a seat tube of the rear frame section.

4. The electric trike of claim 1, wherein the attachment plate includes:
a first sub-plate fixed to the front frame section;
a second sub-plate fixed to the rear frame section; and
multiple bolts that fix the first sub-plate to the second sub-plate.

5. The electric trike of claim 4, wherein the first sub-plate and the second sub-plate include:
upper openings that are completely enclosed and receive one or more of the multiple bolts;
and lower openings that are partially enclosed and receive one or more of the multiple bolts.

6. The electric trike of claim 1, wherein the attachment plate includes two plate extensions that extend under the electric trike and form a cavity to route cables of the electric trike from the front frame section to the rear frame section of the electric trike.

7. The electric trike of claim 1, wherein the rear frame section includes:
a seat tube that extends at an angle towards a rear of the electric trike;
a support post that is fixed to the seat tube to support the seat tube; and
a rear rack that is fixed to the support post via two extension posts.

8. The electric trike of claim 7, wherein the seat tube extends at an angle that is between 60-65 degrees from a horizontal axis of the electric trike.

9. The electric trike of claim 1, wherein the rear frame section includes a rear rack that is fixed to a seat post via a support post that supports the seat post.

10. The electric trike of claim 1, wherein the rear frame section includes:
a rear rack; and
a seat tube that extends at an angle towards a rear of the electric trike to position a seat of the electric trike at least partially above the rear rack.

11. The electric trike of claim 1, wherein the electric trike includes:
a rear rack coupled to a seat post;
a rear post that contains a rear axle and extends between rear wheels of the electric trike; and
multiple rear support posts that support the rear rack.

12. The electric trike of claim 1, wherein the rear frame section includes:
a rear rack having a top surface; and
multiple attachment points disposed in an octagonal pattern on the top surface of the rear rack.

13. A method of assembling an electric trike, the method comprising:
positioning a lower end of a down tube of a front frame section of the electric trike to a lower end of a seat tube of a rear frame section; and
fixing the lower end of the down tube to the lower end of the seat tube via an attachment plate.

14. The method of claim 13, wherein fixing the lower end of the down tube to the lower end of the seat tube via the attachment plate includes:
fixing multiple bolts to a rear sub-plate of the attachment plate that is coupled to the lower end of the seat tube;
slidably attaching a front sub-plate of the attachment plate that is coupled to the lower end of the down tube to the multiple bolts fixed to the rear sub-plate; and
tightening the multiple bolts to secure the front sub-plate to the rear sub-plate.

15. The method of claim 14, wherein slidably attaching the front sub-plate to the multiple bolts fixed to the rear sub-plate includes coupling lower openings of the front sub-plate to the multiple bolts.

16. The method of claim 13, further comprising:
extending multiple cables from a front area of the electric trike to a rear area of the electric trike through an opening formed by plate extensions of the attachment plate.

17. A chain cover for an electric trike, comprising:
a chain guard that surrounds a chain of the electric trike; and
an axle guard that surrounds a rear axle of the electric trike.

18. The chain cover of claim 17, wherein the chain guard is coupled to the axle guard to form a single housing for the chain and the rear axle of the electric trike.

19. The chain cover of claim 17, wherein the axle guard encloses a gearing mechanism of the rear axle of the electric trike.

20. The chain cover of claim 17, wherein the chain guard encloses the chain and a crankset of the electric trike.
